(19) United States
(12) Patent Application Publication
(10) Pub. No.: US 2009/0035201 A1
(43) Pub. Date: Feb. 5, 2009

(54) PREPARATION METHOD OF TC-99M-LABELED IRON OXIDE NANOPARTICLE AND DIAGNOSTIC IMAGING OR THERAPEUTIC AGENT FOR CANCER DISEASES COMPRISING THE SAME

(75) Inventors: Sang Hyun PARK, Jeollabuk-do (KR); Hui Jeong Gwon, Daejon (KR); Sang Mu Choi, Daejon (KR)

Correspondence Address: LUCAS & MERCANTI, LLP, 475 PARK AVENUE SOUTH, 15TH FLOOR, NEW YORK, NY, 10016, US

(73) Assignee: KOREA ATOMIC ENERGY RESEARCH INSTITUTE, Daejon (KR)

(21) Appl. No.: 11/860,111

(22) Filed: Sep. 24, 2007

(30) Foreign Application Priority Data
Jul. 30, 2007 (KR) 10-2007-0076261

(51) Int. Cl. C01G 49/00; B32B 5/16

(52) U.S. Cl. 423/249; 428/402

(57) ABSTRACT

Disclosed herein are a method of preparing a technetium-99m-labeled iron oxide (Fe₂O₃) nanoparticle and a diagnostic imaging or therapeutic agent for cancer diseases comprising the nanoparticle. The ^{99m}Tc-iron oxide nanoparticle is prepared using an acidic solution or a borohydride anion exchange resin as a reducing agent, and thus, is easy to inject into the body, and its biodistribution and excretion from the body is easily predicted. The ^{99m}Tc-iron oxide nanoparticle eliminates cancerous tissues as well as enabling non-invasive real-time imaging for obtaining anatomical information about cancerous tissues and tissue functions without the need for surgery. Also, the iron oxide nanoparticle may be useful as an imaging agent for various diseases including tumors, contagious diseases and genetic defects.

### BACKGROUND OF THE INVENTION

1. Field of the Invention

The present invention relates to a preparation method of a technetium-99m-labeled iron oxide (Fe₂O₃) nanoparticle and a diagnostic imaging or therapeutic agent for cancer diseases comprising the nanoparticle.

2. Description of the Related Art

Hyperthermia is a type of cancer treatment, which uses heat based on the observation that cancer cells are more sensitive to heat than normal cells due to their abnormal environment. Unlike conventional chemotherapy or radiotherapy, hyperthermia therapy has the advantage of selectively killing even very small cancer cells localized or deeply seated inside body organs, without damaging normal cells by maintaining the temperature around cancer cells at an elevated level ranging from 41° C. to 45° C. An in vivo heating technique is required to be developed in order to achieve effective hyperthermia for cancer treatment. Recently, studies have been conducted to develop a self-heating technique using magnetic iron oxide.

Hyperthermia cancer treatment utilizes the characteristic by which magnetic iron oxide heats itself by a coil controlling the frequency and strength of magnetic field to heat and kill cancer cells. Superparamagnetic iron oxide has the following advantages: the magnetic particles do not aggregate during their introduction into the body, can be easily controlled using an externally applied magnetic field, and can be introduced into the body and migrate to a target site merely through simple injection, without requiring separate surgery.

However, when injected into the body, it is difficult to accurately predict the biodistribution and desired pharmacokinetic profiles of magnetic iron oxide, such as the safe removal thereof from the body. In contrast, radioactive isotopes enable easy and accurate in vivo imaging due to their property of emitting radiation. Thus, the drawbacks of magnetic iron oxide can be overcome by labeling magnetic iron oxide with a radioactive isotope.

Nuclear medicine is a branch of medicine that uses atomic energy, and radiopharmaceuticals are essentially required in nuclear medicine. A large number of radioactive isotopes are generated when an atomic reactor is operated. Among them, suitable radioisotopes are selected and processed for use in the diagnosis or treatment of diseases. Such radioactive materials prepared for administration to the body are called radiopharmaceuticals.

The processing of radiopharmaceuticals for diagnostic and therapeutic purposes is accomplished through labeling with a specific selected radioisotope. The radioisotope that is most widely used for labeling radiopharmaceuticals at present is known as technetium-99m (Tc-99m or ^{99m}Tc). Tc-99m has a relatively short half-life of six hours and emits only gamma rays at an energy of 140 keV, which makes it suitable for gamma imaging. Due to these properties, Tc-99m is less toxic to the body and is highly transparent, and thus, is very suitable for administration to the body for imaging purposes. For these reasons, Tc-99m has been widely used in diagnostic and therapeutic radiopharmaceuticals (Sivia, S. J., John, D. L., Potential technetium small molecule radiopharmaceuticals. Chem. Rev. 99, 2205-2218, 1999; Shuang, L., Edwards, D. S., ^{99m}Tc-Labeled small peptides as diagnostic radiopharmaceuticals. Chem. Rev. 99, 2235-2268, 1999).

Korean Pat. Registration No. 638306 describes stabilized Tc-99m radiopharmaceutical compositions, which include both a radioprotectant and one or more antimicrobial preservatives, and thus have an extended lifetime of use.

Korean Pat. Laid-Open Publication No. 2000-0048922 discloses novel radiopharmaceuticals useful for the diagnosis of infection and inflammation, reagents and kits useful for preparing the radiophammaceuticals, methods of imaging sites of infection and/or inflammation in a patient, and methods of diagnosing diseases associated with infection or inflammation in patients in need of such diagnosis.

However, the radiopharnaceutical compositions of Korean Patent 638306, which has an extended lifetime of use because the diagnostic radioisotope Tc-99m and preservatives are used, do not have therapeutic function in cancer cells. Also, the radiopharmaceuticals described in Patent Publication 2000-0048922 are useful for imaging sites of infection or inflammation, but are not suitable in the treatment of specific diseases.

In this regard, the present inventors conducted research onto a method of preparing a ^{99m}Tc-labeled iron oxide nanoparticle complex, and the research resulted in the development of a method of preparing the complex at good radiolabeling efficiency using an acidic solution or a borohydride anion exchange resin as a reducing agent. The ^{99m}Tc-iron oxide nanoparticles, obtained through the method, were found to enable non-invasive real-time imaging to obtain anatomical information about cancerous tissues and tissue functions without the need for surgery. Also, since iron oxide, which is used in the complex according to the present invention, can be used in hyperthermia therapy, the complex may be useful in the treatment of cancer and other diseases in specific areas in the body, thereby leading to the present invention.

### SUMMARY OF THE INVENTION

It is therefore an object of the present invention to provide a method of preparing a Tc-99m-labeled iron oxide nanoparticle.

It is another object of the present invention to provide a diagnostic imaging agent for cancer diseases comprising a Tc-99m-labeled iron oxide nanoparticle.

It is a further object of the present invention to provide a therapeutic agent for cancer diseases comprising a Tc-99m-labeled iron oxide nanoparticle.

In order to accomplish the above objects, the present invention provides a method of preparing a Tc-99m-labeled iron oxide nanoparticle and diagnostic imaging and therapeutic agents for cancer diseases comprising the nanoparticle.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a graph showing the radiochemical purity of Tc-99m-labeled iron oxide nanoparticles according to Example 1 of the present invention;

FIG. 2 is a graph showing the radiochemical purity of Tc-99m-labeled iron oxide nanoparticles according to Example 2 of the present invention;

FIG. 3 is a transmission electron micrograph of Tc-99m-labeled iron oxide nanoparticles according to Example 1 of the present invention; and

FIG. 4 is a transmission electron micrograph of Tc-99m-labeled iron oxide nanoparticles according to Example 2 of the present invention.

### DESCRIPTION OF THE PREFERRED EMBODIMENTS

The present invention provides a method of preparing a Tc-99m-labeled iron oxide nanoparticle represented by Chemical Formula 1, the method comprising reacting iron oxide (Fe₂O₃) with alkali metal pertechnetate (M^{99m}TcO₄) in an acidic solvent according to Reaction 1, below.

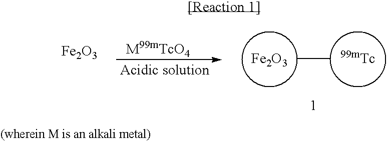

In the preparation method according to the present invention, the Tc-99m-labeled iron oxide nanoparticle represented by Chemical Formula 1 is obtained by reacting iron oxide (Fe₂O₂) with alkali metal pertechnetate (M^{99m}TcO₄) in an acidic solvent. The alkali metal pertechnetate is sodium pertechnetate, which is preferably dissolved in an acidic solvent, such as hydrochloric acid, nitric acid or sulfuric acid, and more preferably in a solution of hydrochloric acid. In the acidic solution, pertechnetate ions are reduced, leading to an increase in labeling efficiency. The reaction is preferably carried out at 98° C. to 100° C. for a period ranging from 20 to 40 minutes.

In addition, the present invention provides another method of preparing a Tc-99m-labeled iron oxide nanoparticle, represented by Chemical Formula 1.

The above Tc-99m-labeled iron oxide nanoparticle represented by Chemical Formula 1 is obtained by reacting iron oxide (Fe₂O₃) with alkali metal pertechnetate (M^{99m}TcO₄) in a borohydride anion exchange resin according to Reaction 2, below.

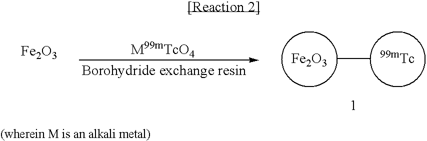

In the above method according to the present invention, the use of a borohydride exchange resin (BER) as a reducing agent results in high yields of technetium complexes through reaction at room temperature for a period ranging from 20 to 40 minutes, and eliminates the need for pH readjusting using conventional methods. Also, since the borohydride reducing agent reacts not in an aqueous phase but in a solid phase, it is easily removed through filtration even upon excessive use thereof after the reaction is completed. Thus, the present method is simple and cost-effective compared to conventional methods.

The borohydride exchange resin has a structure in which a borohydride ion (BH₄⁻) is bonded to a cation, which is supported on a polymer. The cation used for the immobilization of the borohydride ion has quaternary ammonium functionality. The borohydride ion can be immobilized on any anion exchange resin having quaternary ammonium functionality. Such an exchange resin supported with the borohydride ion is easily commercially available, and is exemplified by polystyrene, high density polyethylene and Amberlite.

The BER is advantageous in terms of being stable across most of the pH range, including extremely acidic and alkaline conditions, and is thus easily applicable to biomolecules, as well as being easily removable through filtration when being administered.

The reaction using the BER according to the present invention is conducted at room temperature, at which the problems associated with reaction at high temperature, inconvenience in handling, and chemical bond breaking, are avoided, thereby minimizing side reactions.

Thus, the Tc-99m-labeled iron oxide nanoparticle represented by Chemical Formula 1, which is prepared by the method of Reaction 1 or 2, has a structure in which the radioactive Tc-99m is coordinate-bonded to an iron oxide (Fe₂O₃) nanoparticle, and has a particle size ranging from 5 nm to 70 nm in diameter.

Further, the present invention provides a diagnostic imaging agent or a therapeutic agent for cancer diseases comprising the Tc-99m-labeled iron oxide nanoparticle represented by Chemical Formula 1, which is prepared through the method of Reaction 1 or 2.

The radioisotope that is most widely used at present for labeling radiopharmaceuticals is known as technetium-99m (Tc-99m or ^{99m}Tc) Tc-99m has a relatively short half-life of six hours and emits only gamma rays at energy of 140 keV, making it suitable for gamma imaging. Due to these properties, Tc-99m is less toxic to the body and highly transparent, and thus is very suitable for administering into the body for imaging. For these reasons, Tc-99m has been widely used in diagnostic and therapeutic radiopharmaceuticals (Sivia, S. J., John, D. L., Potential technetium small molecule radiopharmaceuticals. Chem. Rev. 99, 2205-2218, 1999; Shuang, L., Edwards, D. S., ^{99m}Tc-Labeled small peptides as diagnostic radiopharmaceuticals. Chem. Rev. 99, 2235-2268, 1999).

Hyperthermia cancer treatment utilizes the characteristic by which magnetic iron oxide self-heats by a coil controlling the frequency and strength of magnetic field in order to heat and kill cancer cells. Superparamagnetic iron oxide has the following advantages: the magnetic particles do not aggregate during their introduction into the body, are easily controlled using an externally applied magnetic field, and can be introduced into the body and migrate to a target site merely through simple injection, without requiring separate surgery.

Thus, the Tc-99m-labeled iron oxide nanoparticle according to the present invention is useful as a contrast agent for imaging body organs, and is also useful as a therapeutic agent for cancer due to its ability to kill cancer cells.

A better understanding of the present invention may be obtained through the following examples which are set forth to illustrate, but are not to be construed as the limit of the present invention.

### Example 1

### Preparation 1 of Tc-99m-Iron Oxide Nanoparticles

2.5 mg of iron oxide (Fe₂O₃, Aldrich), 10 mCi/ml of Tc-99m and 0.3 ml of 1N hydrochloric acid were added to a 10-ml glass vial, and were heated with stirring for 30 min in a nitrogen atmosphere. The resulting reaction solution was passed through a 300-μm sieve to obtain Tc-99m-labeled iron oxide nanoparticles. The Tc-99m-labeled iron oxide nanoparticles were passed through a 0.45-μm filter. Then, the filtrate was washed with water until radioactivity was detected at a very weak level, thereby obtaining final Tc-99m-labeled iron oxide nanoparticles.

### Example 2

### Preparation 2 of Tc-99m-Iron Oxide Nanoparticles

2.5 mg of iron oxide (Fe₂O₃, Aldrich) and 10 mCi/ml of Tc-99m were added to a 10-ml glass vial containing 5 mg of a borohydride anion exchange resin (Tetraborohydride Exchange Resin, Aldrich), and were stirred at room temperature for 30 min under nitrogen atmosphere. The resulting reaction solution was passed through a 300-μm sieve to separate Tc-99m-labeled iron oxide nanoparticles from the BER. The Tc-99m-labeled iron oxide nanoparticles were passed through a 0.45-μm filter. Then, the filtrate was washed with water until radioactivity was detected at a very weak level, thereby obtaining final Tc-99m-labeled iron oxide nanoparticles.

### Experimental Example 1

### Evaluation of Labeling Efficiency of Tc-99m-Iron Oxide Nanoparticles

The radiochemical purity of the Tc-99m-iron oxide nanoparticles was determined using instant thin layer chromatography (ITLC).

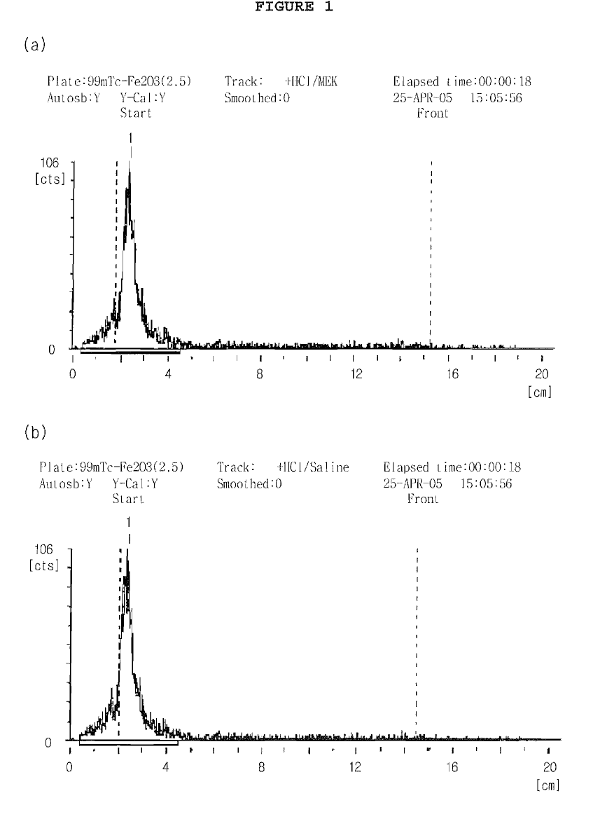

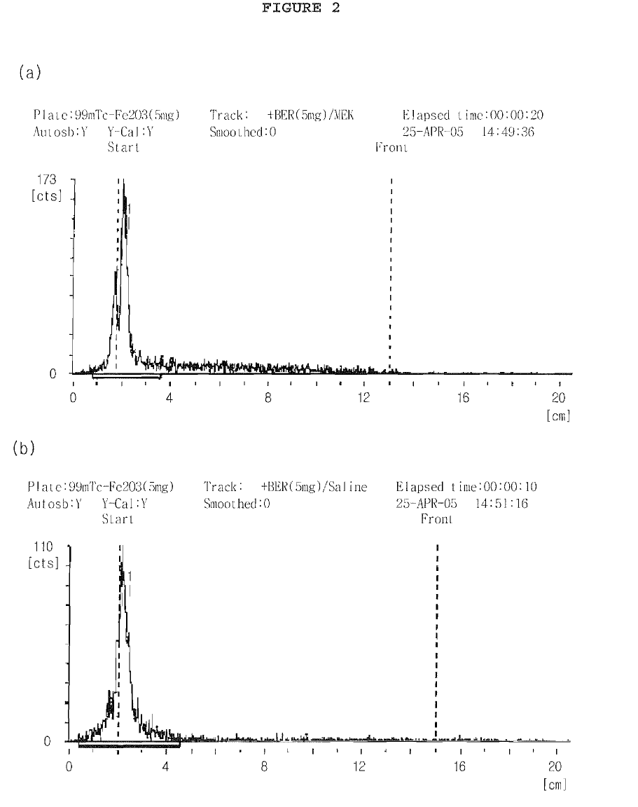

The ITLC was performed using a silica gel-coated fiber sheet (Gelman Sciences Inc., Ann Arbor, Mich., USA). The Tc-99m-iron oxide nanoparticles prepared in Examples 1 and 2 were spotted on an ITLC-SG strip. The strip was developed using either methyl ethyl ketone (MEK) or physiological saline as a developing solvent. After the ITLC was completed, the labeling efficiency of the labeled complexes of Examples 1 and 2 was determined, and the results are given in FIGS. 1 and 2, respectively. The measured results are again expressed as a percentage, and are given in Table 1, below. In FIGS. 1 and 2, panel (a) indicates labeling efficiency in MEK, and panel (b) indicates labeling efficiency in physiological saline.

TABLE 1

| | | ^{99m}Tc species | | |
|---|---|---|---|---|
| Chromatography | | | | Amount |
| system | | | Amount detected | detected at |
| | Support | Solvent | at the origin | the solvent front |
| Example 1 | ITLC-SG | MEK | ^{99m}Tc-Fe₂O₃ 100% | ^{99m}TcO₄ 0% |
| | ITLC-SG | Saline | ^{99m}Tc-Fe₂O₃ 100% | ^{99m}TcO₄ 0% |
| Example 2 | ITLC-SG | MEK | ^{99m}Tc-Fe₂O₃ 100% | ^{99m}TcO₄ 0% |
| | ITLC-SG | Saline | ^{99m}Tc-Fe₂O₃ 100% | ^{99m}TcO₄ 0% |

As shown in FIGS. 1 and 2 and Table 1, both of the labeled complexes of Examples 1 and 2 were found to have a radiochemical purity of 100%. The amount of free pertechnetate migrated with the solvent front was detected as 0% in both MEK and physiological saline, which were used as a developing solvent. ^{99m}Tc—Fe₂O₃ was found not to migrate with the solvent front, but was detected at the origin. The amount of ^{99m}Tc—Fe₂O₃ was detected as 100% at the origin in both MEK and physiological saline. These results indicated that iron oxide in the radiolabeled complexes was labeled with Tc-99m at high efficiency.

### Experimental Example 2

### Evaluation of Stability of Tc-99m-Iron Oxide Nanoparticles

The stability of the ^{99m}Tc—Fe₂O₃ nanoparticles prepared in Examples 1 and 2 was measured as follows.

The ^{99m}Tc—Fe₂O₃ nanoparticles were placed into a closed vial and incubated at room temperature. At 1, 2, 4 and 6 hr, the nanoparticles was evaluated for their stability by measuring radiolabeling efficiency. The results are given in Table 2, below.

TABLE 2

Time (h)

| | 1 | 2 | 4 | 6 |
|---|---|---|---|---|
| Radiolabeling | 100 | 100 | 100 | 98 |
| efficiency | | | | |
| (%) | | | | |

As shown in Table 2, the radiolabeled nanoparticles were found to maintain radiolabeling efficiency of 98% for 6 hrs after being labeled with Tc-99m. These results indicated that the ^{99m}Tc—Fe₂O₃ nanoparticles were stable for at least 6 hrs.

### Experimental Example 3

### Characterization of Size of Tc-99m-iron Oxide Nanoparticles

The size of the Tc-99m-iron oxide nanoparticles prepared in Examples 1 and 2 was estimated using transmission electron microscopy (TEM).

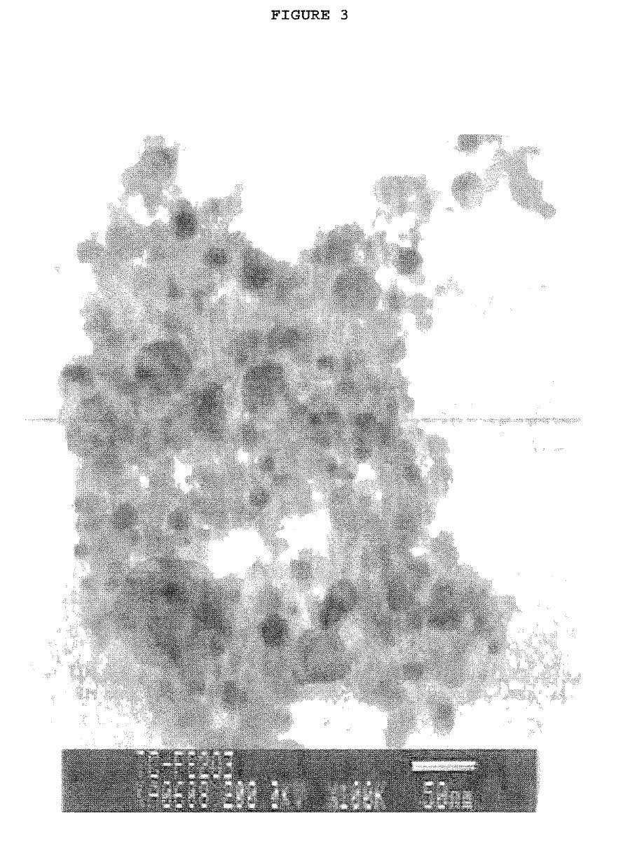

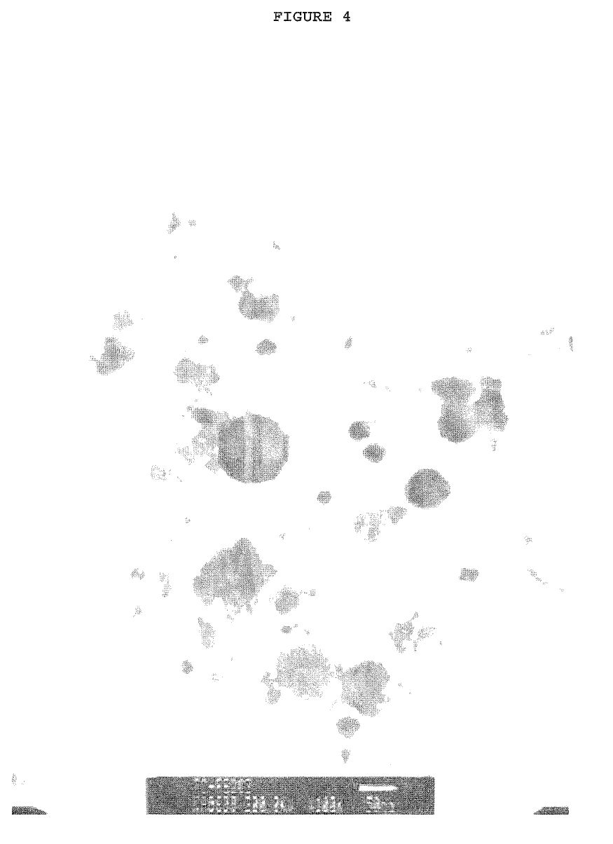

A solution of the Tc-99m-iron oxide nanoparticles was sterilized using a membrane filter (0.22 μm), placed into a sterile reaction vial, and cold-preserved. Then, the nanoparticle solution was dropped onto a plastic-coated (carbon-coated) copper grid (300 mesh), and was observed under a transmission electron microscope. The results are given in FIGS. 3 and 4.

As shown in FIGS. 3 and 4, both of the Tc-99m-iron oxide nanoparticles of Examples 1 and 2 were found to have a spherical shape and a particle size ranging from 5 nm to 70 nm.

As described hereinbefore, the present invention provides ^{99m}Tc-iron oxide nanoparticles, which are prepared using an acidic solution or a borohydride anion exchange resin as a reducing agent. The radiolabeled iron oxide nanoparticles are easy to inject into the body, and their biodistribution and excretion from the body are easily predicted. The ^{99m}Tc-iron oxide nanoparticles, which are prepared by the present method, eliminate cancerous tissues as well as enabling non-invasive real-time imaging for anatomical information of cancerous tissues and tissue functions without the need for surgery. Also, the iron oxide nanoparticles may be useful as an imaging agent for various diseases including tumors, contagious diseases and genetic defects.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of preparing a Tc-99m-labeled iron oxide nanoparticle represented by Chemical Formula 1, the method comprising reacting iron oxide (Fe₂O₃) with alkali metal pertechnetate (M^{99m}TcO₄) in an acidic solvent according to the following Reaction 1:

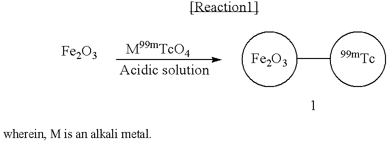

2. The method as set forth in claim 1, wherein the acidic solvent is one selected from the group consisting of hydrochloric acid, nitric acid and sulfuric acid.

3. The method as set forth in claim 1, wherein the reaction is carried out at a temperature ranging from 98° C. to 100° C.

4. The method as set forth in claim 1, wherein the reaction is carried out for a period ranging from 20 to 40 minutes.

5. A method of preparing a Tc-99m-labeled iron oxide nanoparticle represented by Chemical Formula 1, the method comprising reacting iron oxide (Fe₂O₃) with alkali metal pertechnetate (M^{99m}TcO₄) in a borohydride anion exchange resin according to the following Reaction 2:

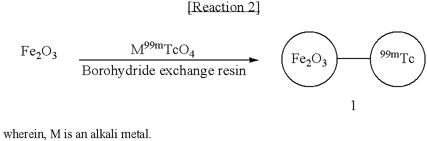

6. The method as set forth in claim 5, wherein the reaction is carried out at room temperature.

7. The method as set forth in claim 5, wherein the reaction is carried out for a period ranging from 20 to 40 minutes.

8. A diagnostic imaging agent for cancer diseases comprising a Tc-99m-labeled iron oxide nanoparticle represented by Chemical Formula 1, below.

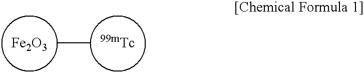

9. A therapeutic agent for cancer diseases comprising a Tc-99m-labeled iron oxide nanoparticle represented by Chemical Formula 1, below. [chemical structure]
